(19) United States
(12) Patent Application Publication
(10) Pub. No.: US 2025/0361853 A1
(43) Pub. Date: Nov. 27, 2025

(54) SELF-RELEASING LIFTING YOKE FOR WIND TURBINE BLADE INSTALLATIONS AND ASSOCIATED METHOD

(71) Applicant: Vestas Wind Systems A/S, Aarhus N (DK)

(72) Inventors: Joris Kofman, Aalborg Øst (DK); Jakob Sørensen, Fredericia (DK)

(73) Assignee: Vestas Wind Systems A/S, Aarhus N (DK)

(21) Appl. No.: 18/874,886

(22) PCT Filed: Jun. 21, 2023
(86) PCT No.: PCT/DK2023/050156

§ 371 Date: Dec. 13, 2024

(30) Foreign Application Priority Data
Jun. 30, 2022 (DK) PA 202270353

(51) Int. Cl. F03D 13/10; B66C 1/10

(52) U.S. Cl. CPC F03D 13/104; B66C 1/108; F05B 2230/61

(57) ABSTRACT

A lifting yoke (30) supports and moves a wind turbine blade (20) during installation or service at a wind turbine (10). The lifting yoke (30) includes an elongate support beam (42) configured to be lifted and moved by a crane (32), a support element (96) connected to a first end (48) of the support beam (42), and a cradle support (58) connected to a second end (50) of the support beam (42). The support element (96) wraps around the blade (20) proximate a root end (22), while the cradle support (58) lifts and supports the blade (20) at a location between a center of gravity and a tip end (24) of the blade (20). The cradle support (58) includes a support bed (60) with an upper profiled surface (66) that contacts a downward-facing surface (44b) of the blade (20), and also includes a release device (72) and a brake device (76). The release device (72) disconnects one end (62) of the support bed (60) from the support beam (42) to allow the support bed (60) to pivot away from the blade (20), while the brake device (76) controls and slows the pivotal movement of the support bed (60) over a first portion of pivotal movement, thereby avoiding uncontrolled swinging that could impact the blade (20) again. The lifting yoke (30) is simplified in construction by having actively controlled elements only at the release device (72) and brake device (76), while providing improved lifting support for blades (20) that avoids localized points of high stress that can occur when lifting blades (20) with slings.

### TECHNICAL FIELD

This application relates generally to wind turbines and, more particularly, relates to yoke-type installation assist devices and methods used to support a wind turbine blade during lifting and connection to a rotor of a wind turbine.

### BACKGROUND

Wind turbines are used to produce electrical energy using a renewable resource and without combusting a fossil fuel. Generally, a wind turbine converts kinetic energy from the wind into electrical power. A conventional wind turbine installation includes a foundation, a tower supported by the foundation, and an energy generating unit positioned atop of the tower. The energy generating unit typically includes one or more nacelles to house several mechanical and electrical components, such as a generator, gearbox, and main bearing, and the wind turbine also includes a rotor operatively coupled to the components in the nacelle through a main shaft extending from the nacelle. Single rotor wind turbines and multi-rotor wind turbines (which may have multiple nacelles) are known, but for the sake of efficiency, the following description refers primarily to single rotor designs. The rotor, in turn, includes a central hub and a plurality of blades extending radially therefrom and configured to interact with the wind to cause rotation of the rotor. The rotor is supported on the main shaft, which is either directly or indirectly operatively coupled with the generator which is housed inside the nacelle. Consequently, as wind forces the blades to rotate, electrical energy is produced by the generator. Wind power has seen significant growth over the last few decades, with many wind turbine installations being located both on land and offshore.

A wind turbine blade is a very large and complex structure that must be constructed to withstand long-term service in an abusive environment, while also maximizing lift and minimizing drag forces. Despite the large size and unique shape/profile for each blade, it is important to avoid causing any stress damages to the blade when lifting the blade into position for installation at a wind turbine (and/or during a disconnection of the blade for conducting repairs periodically). This need for lifting and precise support of wind turbine blades presents several technical difficulties, and several types of conventional solutions have been provided to address these needs in the wind turbine field.

One conventional type of lifting device is known as a T-yoke, this lifting device including a T-shaped support beam that carries at least two support slings or saddles. The T-yoke does not contain any hydraulics or actively controlled components, but this results in a need to “thread” and “unthread” the support beam and the support slings or saddles all the way along the longitudinal length of the wind turbine blade before and after use (this is because a root end of the blade is often attached before use, which means the slings or saddles must be moved from the open tip end all the way to and from the position in use, which is typically around a center of gravity that is closer to the root end of the blade where the majority of the blade mass is located. Particularly when operating a crane on a ground surface to lift wind turbine blades up to a rotor of a wind turbine, the need for precise guidance of the T-yoke along this significant length of the wind turbine blade (to avoid impacting or damaging the blade during “unthreading” movements) is difficult without repositioning the crane or placing the crane in a location that is not ideal for support of the wind turbine blade during the installation process.

Another conventional type of lifting device is known as a multi-blade installer device, and such a device typically includes onboard electronics and hydraulics for operating various devices including C-shaped clamps for engaging with a wind turbine blade. Such installer devices are difficult to modify and adapt for different shapes and sizes of blades to be moved, which limits their technical applicability in the field. Likewise, all the onboard electronics, control devices, and hydraulics leads to significant additional weight and complexity of manufacture, which makes it more difficult for the crane to operate in use (while also exacerbating the problem of lack of versatility to handle different wind turbine blade profiles and designs). Furthermore, the clamps used on installer devices and the slings or saddles used with the T-yokes can cause significant bending loads and/or localized high stress applications to the blade, which is undesirable as such can lead to damage in the installation process.

Some of these various technical problems have tried to be addressed in the conventional art, but the existing solutions still do not balance all the needs of wind turbine installation processes. For example, one known reference in this field is U.S. Pat. No. 9,926,907 to Wobben Properties GmbH, and this reference shows lifting of a wind turbine blade with a hoisting rope that can be selectively disconnected using pulling force applied on auxiliary ropes connected to release devices. However, the lifting is done by ropes that would apply significant localized stresses and bending forces, so even though the hoisting rope may be automatically disengaged from the blade, a desired support for the wind turbine blade is not provided. Another known reference in this field is U.S. Pat. No. 8,595,931 to General Electric Company, and this reference illustrates lifting of a wind turbine blade with a sling that includes a quick release device for unwrapping the sling after the blade is installed at the wind turbine. Once again, the lifting is done by conventional slings that are not ideal for avoiding significant bending forces and/or localized stress concentrations during the movement and lifting of the blade.

Further improvements for lifting yokes used during installation and repair of wind turbine blades are therefore desired. To this end, it is desirable to further improve the lifting yokes to provide better support of the blade while also minimizing operational complexity and also allowing for better adaptability or versatility for use with different blade profiles and designs.

### SUMMARY

To these and other ends, a first aspect of the invention is directed to a lifting yoke for supporting and moving a wind turbine blade during installation or service at a wind turbine. The blade includes a root end, a tip end opposite the root end, and a center of gravity located therebetween. The lifting yoke includes an elongate support beam configured to be lifted and moved by a crane, where the support beam includes a first end and a second end along a length of the support beam, a support element connected to the first end of the support beam and configured to wrap around the blade proximate the root end of the blade, and a cradle support connected to the second end of the support beam and configured to lift and support the blade at a location between the center of gravity and the tip end. The cradle support includes a support bed having an upper profiled surface that is configured to receive and support a downward-facing surface of the blade, where the support bed extends along a length generally transverse to the length of the support beam and between a first bed end and a second bed end, and where each of the first and second bed ends are connected by a separate line to the second end of the support beam. The cradle support further includes a release device connected to the line at the first bed end and operative to disconnect the first bed end from the second end of the support beam, thereby allowing the support bed to pivot about the second bed end away from the blade. Additionally, the cradle support includes a brake device operatively connected to the first bed end, the brake device being configured for controlling the pivotal movement of the support bed for a first portion of movement following disconnection of the first bed end from the second end of the support beam by the release device. The brake device being configured for disengaging after the first portion of movement to allow continued pivotal movement of the support bed about the second bed end while the second bed end remains connected by the line to the second end of the support beam. The control by the brake device may be provided so as to be slowing down the pivotal movement of the support bed for a first portion of movement following disconnection of the first bed end from the second end of the support beam by the release device.

In one embodiment, the first portion of movement may include at least 45° of pivotal rotation of the support bed about the second bed end, such that the brake device only disengages after at least 45° of pivotal rotation.

In one embodiment, the line connecting the first bed end to the second end of the support beam may be a primary connection line that is engaged with the release device, and the lifting yoke may further include a secondary control line connecting the first bed end with the second end of the support beam and running generally parallel to the primary connection line. In this embodiment, the brake device may engage with the secondary control line such that the secondary control line continues to initially maintain a connection between the first bed end and the second end of the support beam after the release device disconnects the primary connection line from one of the first bed end and the second end of the support beam.

In one embodiment, the brake device may include a motor and a resistor connected to the motor configured for applying a braking torque or force to movement of the secondary control line past the motor. The braking torque or force slows the release of the secondary control line past the motor such that the pivotal movement of the support bed downwardly at the first bed end is limited in speed through the first portion of movement.

In an alternative embodiment, the brake device may include a winch device that receives the secondary control line and configured for actively controlling movements of the secondary control line relative to the first bed end. The winch device operates to limit a speed of release of the secondary control line through the winch device such that the pivotal movement of the support bed downwardly at the first bed end is limited in speed through the first portion of movement.

In one embodiment, the release device may include a release pin connected to the primary connection line, and a motor and a pin receptacle connected to the support bed. The motor operates selectively to disengage the release pin from the pin receptacle to thereby disconnect the primary connection line from the support bed.

In one embodiment, each of the release device and the brake device may be mounted on the support bed and adjacent the first bed end. Furthermore, in one embodiment, each of the release device and the brake device may include an antenna for wirelessly receiving control signals to operate the respective disconnecting and slowing pivotal movement functions.

In one embodiment, the upper profiled surface of the support bed may be adapted to match an actual size and shape profile of the blade to be supported at the cradle support.

In one embodiment, the elongate support beam may be a T-shaped beam including a transverse beam member extending along the second end, and opposite ends of the transverse beam member being connected by the separate lines to the first and second bed ends of the cradle support.

In one embodiment, the support element connected to the first end of the support beam may include one of the following: a support sling defined by a generally flexible length of material configured to wrap closely around the blade proximate the root end, or a second cradle support including a support bed with an upper profiled surface, a release device, and a brake device each functioning identically to corresponding elements of the cradle support connected to the second end of the support beam.

In one embodiment, after installation or service of the wind turbine blade, and when each of (i) the cradle support connected to the second end of the support beam and (ii) the support sling or second cradle support connected to the first end of the support beam is released from engagement with the blade, the lifting yoke can be moved directly away from the blade without moving the lifting yoke along an entire length of the blade and/or over the tip end thereof.

In one embodiment, the release device and the brake device may define the only actively controlled elements on the lifting yoke.

A second aspect of the invention is directed to a method of moving and supporting a wind turbine blade during installation or service at a wind turbine. The blade includes a root end, a tip end opposite the root end, and a center of gravity therebetween. The method includes positioning an elongate support beam of a lifting yoke to be spaced apart from an upward-facing surface of the blade and above the center of gravity of the blade, with the elongate support beam extending from a first end located proximate the root end of the blade to a second end located above the blade between the center of gravity and the tip end of the blade; connecting a support element to the first end of the support beam and wrapping the support element around the blade to support the blade proximate the root end; connecting a cradle support to the second end of the support beam, the cradle support including a support bed with an upper profiled surface and extending between first and second bed ends, a release device, and a brake device, and engaging the cradle support with the blade at a location between the center of gravity and the tip end by contacting the upper profiled surface with the blade while the first and second bed ends are connected to the second end of the support beam with separate lines; lifting the lifting yoke at the elongate support beam to thereby lift and support the blade at the support element and at the cradle support; and releasing engagement of the cradle support from the blade when installation or service of the blade is completed. The releasing step includes activating the release device of the cradle support to disconnect the line at the first bed end from the support bed, and controlling, by the brake device, a speed of pivotal movement of the support bed downwardly after activating the release device to slow the pivotal movement about the second bed end for at least a first portion of the pivotal movement.

In one embodiment, the first portion of the pivotal movement may include at least 45° of pivotal rotation of the support bed about the second bed end, and the step of releasing engagement of the cradle support from the blade may further include disengaging the brake device only after the support bed has moved through at least 45° of pivotal rotation, thereby allowing the support bed to freely continue the pivotal movement downward and away from the blade.

In one embodiment, the line connecting the first bed end to the second end of the support beam may be a primary connection line, the lifting yoke may further include a secondary control line connecting the first bed end with the second end of the support beam, and the step of connecting the cradle support to the second end of the support beam may further include engaging the release device with the primary connection line such that the release device is configured to selectively disconnect the primary connection line from the first bed end, and engaging the brake device with the secondary control line such that the brake device is configured to control movements of the first bed end along the secondary control line.

In one embodiment, the brake device may include a motor and a resistor connected to the motor, and the step of controlling the speed of pivotal movement may further include applying a braking torque or force with the motor and the resistor to limit movement of the secondary control line past the motor.

In an alternative embodiment, the brake device may include a winch device, and the step of controlling the speed of pivotal movement may further include actively controlling, by the winch device, a speed of movement of the secondary control line through the winch device.

In one embodiment, each of the release device and the brake device may include an antenna for wireless communications of control signals, and the step of releasing engagement of the cradle support may further include sending wireless control signals to the antennas of the release device and the brake device to remotely and sequentially cause the step of activating the release device and the step of controlling the speed of pivotal movement with the brake device.

In one embodiment, after the step of releasing engagement of the cradle support from the blade, the method may further include disengaging the support element from the blade proximate the root end of the blade, and moving the lifting yoke transversely and directly away from the blade without moving the lifting yoke along an entire length of the blade and/or over a tip end thereof.

The steps and elements described herein can be reconfigured and combined in many different combinations to achieve the desired technical effects in different styles of wind turbines, as may be needed in the art.

### BRIEF DESCRIPTION OF THE DRAWINGS

The accompanying drawings, which are incorporated in and constitute a part of this specification, illustrate one or more embodiments of the invention and, together with a general description of the invention given above, and the detailed description given below, serve to explain the invention.

FIG. 1 is a perspective view of a wind turbine including a plurality of blades that may be installed using the lifting yoke according to embodiments of the invention.

FIG. 2 is a front view of a wind turbine blade of the wind turbine of FIG. 1, specifically being lifted into a position for installation by a crane (shown in phantom) using the lifting yoke according to one embodiment of the invention.

FIG. 3 is an end view of the wind turbine blade of FIG. 2, taken along a cross-section proximate a cradle support of the lifting yoke and showing the wind turbine blade being fully supported by the cradle support along the region of this cross-section in a first operational state of the lifting yoke.

FIG. 4 is an end view of the wind turbine blade similar to FIG. 3, but with the lifting yoke in a second operational state in which the cradle support is released from underneath the wind turbine blade and pivots away from the blade in a controlled manner.

FIG. 5 is an end view of the wind turbine blade similar to FIG. 4, but with the lifting yoke in a third operational state in which the cradle support has fully pivoted downwardly away from the wind turbine blade and is ready for removal from the proximity of the blade.

FIG. 6 is a front view of the wind turbine blade, crane, and lifting yoke similar to FIG. 2, but with the cradle support being pivoted away from the blade as shown in FIG. 5 and with a support element in the form of a support sling also released from a root end of the blade in this configuration, such that the crane can readily move the lifting yoke away from the blade as shown.

### DETAILED DESCRIPTION

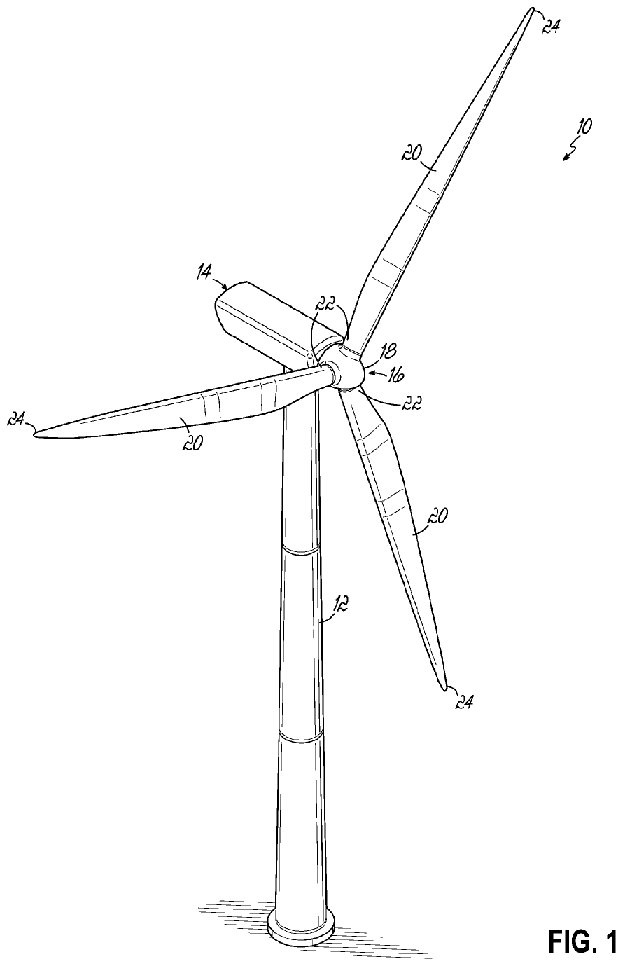

With reference to FIGS. 1 through 6, one embodiment of a self-releasing lifting yoke that may be used in a method of installing or servicing a wind turbine blade at a wind turbine is shown in detail. The lifting yoke is configured to provide a bed or saddle-style lifting support for a body of the wind turbine blade that can be customized to the shape of the blade so as to avoid applying localized points of high stress during the lifting or movements of the blade, while accomplishing such lifting with a simplified construction that includes only a limited number of actively-controlled elements for operating the lifting yoke. To this end, the lifting yoke includes an elongate support beam connected to at least one cradle support with a support bed that can pivot away from engagement with a downward-facing surface of the blade after repair or installation actions are completed, and this pivotal movement is actuated and controlled by a release device and a brake device provided on the cradle support. As a result, the cradle support can be released from the blade when installation or repair work is done and the support beam can then be used to directly move the at least one cradle support away from the blade, e.g., without necessitating that the blade support elements be “unthreaded” from the blade by moving these along an entire length and/or over the tip end of the blade. The lifting yoke of the present invention thus provides a more desirable support for the blade while advantageously maintaining a simplified structure and movement/operation, thereby allowing a crane to easily move the lifting yoke at the support beam, and without necessitating complex controls or operational equipment to be provided by the crane for the lifting yoke. Other advantages and effects of the embodiments of this invention will be evident from the following description.

Turning with reference to FIG. 1, a wind turbine 10 is shown to include a tower 12, a nacelle 14 disposed at the apex of the tower 12, and a rotor 16 operatively coupled to a generator (not shown) housed inside the nacelle 14. The rotor 16 of the wind turbine includes a central hub 18 and a plurality of wind turbine blades 20 that project outwardly from the central hub 18 at locations circumferentially distributed around the hub 18. As shown, the rotor 16 includes three wind turbine blades 20, but the number 10 of blades 20 may vary from one wind turbine to another. The wind turbine blades 20 are configured to interact with air flow to produce lift that causes the rotor 16 to spin generally within a plane defined by the wind turbine blades 20. As the rotor 16 spins, the wind turbine blades 20 pass through the air with a leading edge leading the respective wind turbine blade 20 during rotation. Each wind turbine blade 20 extends longitudinally from a root end 22 connected to the rotor 16 to a tip end 24. As readily understood from this illustration in FIG. 1, the wind turbine blades 20 in use are spaced apart from the ground surface that the tower 12 sits upon by a significant distance, which therefore typically requires a large crane (not shown in FIG. 1) or the like to raise each of the blades 20 into position for attachment to or removal from the hub 18 whenever installation or repair actions are necessary. As noted above, various yokes or installer equipment have been developed for use when lifting and moving one of the blades 20 by the crane, but these conventional designs continue to have deficiencies as set forth in the Background above. However, the lifting yoke of this invention provides improved support of the blade 20 and simplified interfacing and operations with the crane, as will be set forth in detail below, which improves the speed and reliability by which repair and installation actions for wind turbine blades 20 can be performed at the wind turbine 10.

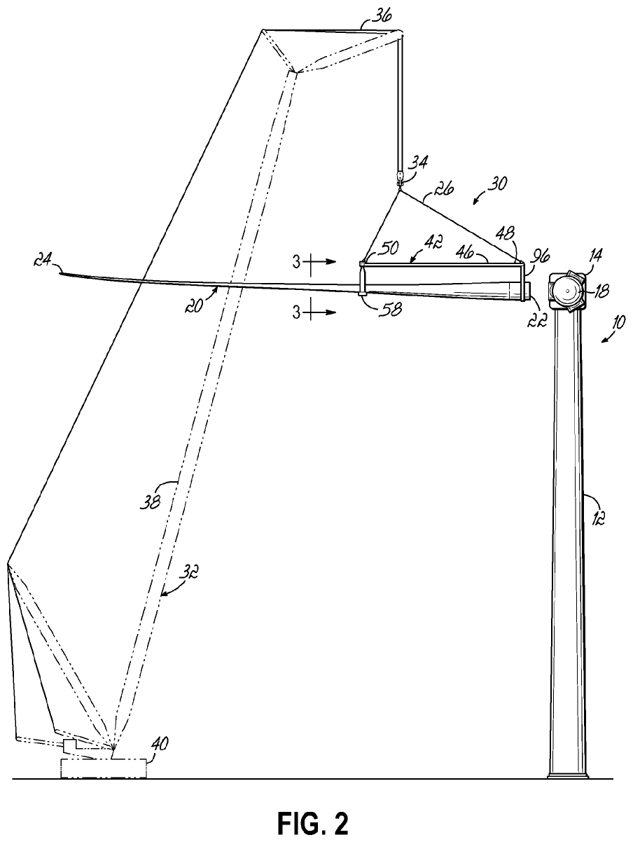

In FIG. 2, the lifting yoke 30 in accordance with embodiments of the present invention is shown supporting one of the wind turbine blades 20 during an installation process at the wind turbine 10. In this view, the crane 32 (shown partially in phantom) used to lift and position the lifting yoke 30, and thereby also lift and position the blade 20, is also shown. The crane 32 is of standard construction, including a hook 34 configured to move the lifting yoke 30 via a control harness 26 or wire connected to the lifting yoke 30, a hoist 36 defined by one or more lift wires extending from the hook 34, and a boom/jib assembly 38 (in phantom for exemplary purposes only) that positions and supports the hoist 36 as it extends between a main body 40 (also shown in phantom) of the crane 32 and the hook 34. When lifting the blade 20, the hook 34 is generally positioned above a center of gravity of the blade 20, which is defined partway along the longitudinal length of the blade 20 that extends between the root end 22 and the tip end 24. Consequently, the lifting yoke 30 is provided with multiple supports that engage with the blade 20 on opposite sides of the center of gravity as shown, thereby allowing balancing and full support and retention of the weight of the blade 20 during movement and installation/repair actions. These multiple supports in the illustrated embodiments and the other elements of the lifting yoke 30 will now be described in further detail.

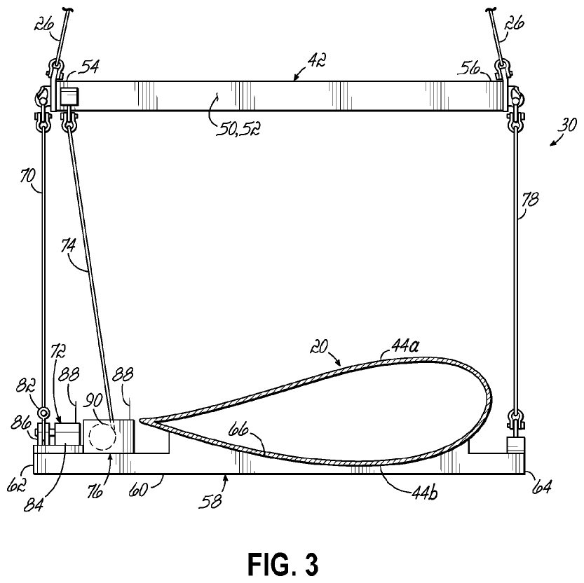

With continued reference to FIG. 2 as well as FIG. 3, the elements of the lifting yoke 30 in this embodiment are shown in a first state of operation, which may be referred to as a blade support position. The lifting yoke 30 first includes an elongate support beam 42 carrying the control harness 26 and configured for operative connection to the hook 34 of the crane 32. The support beam 42 in use is positioned spaced apart from and generally directly above an upward-facing surface 44a of the blade 20 (the specific cross-sectional shape or profile of the blade 20 shown in these Figures is exemplary only and may vary for each different wind turbine 10). The support beam 42 of this embodiment is a T-shaped beam including a longitudinal beam member 46 that extends between a first end 48 and a second end 50 of the support beam 42, and a transverse beam member 52 that extends perpendicular to the longitudinal beam member 46 at the second end 50. The longitudinal beam member 46 extends generally along the length of the blade 20 when the lifting yoke 30 is in use, such that the first end 48 is located generally above the root end 22 of blade 20 while the second end 50 is generally above a location on the blade 20 between the center of gravity and the tip end 24 thereof. Although not shown, the longitudinal beam member 46 connects to the transverse beam member 52 generally along a center of the transverse beam member 52 to define the T-shape for the support beam 42. The control harness 26 is connected to the first end 48 of the longitudinal beam member 46 and to opposite ends 54, 56 of the transverse beam member 52, as shown by the eyelet-style connections shown most clearly in FIG. 3. The transverse beam member 52 is configured to be connected to and support a cradle support 58 as described further below, and a separate support element 96 is configured to be connected to the first end 48 of support beam 42 to wrap around and thereby support the blade 20 proximate the root end 22. While a T-shaped beam for the support beam 42 is shown in this embodiment and described accordingly, it will be understood that variations are possible for the support beam 42 depending on the types of supports used to engage with the stated portions of the blade 20 in other embodiments. Regardless, the support beam 42 is fairly similar to those used with conventional T-yokes in that no actively controlled devices or hydraulics are required/included in this portion of the lifting yoke 30.

The cradle support 58 and its elements are shown most clearly in FIG. 3, which is a cross-sectional view taken generally along line 3-3 in FIG. 2, e.g., the cross section is through the blade 20 but the cradle support 58 and the second end 50 of the support beam 42 are illustrated in a facing end view. The cradle support 58 is engaged with the blade 20 (at a location between the center of gravity and the tip end 24) in a blade support position in FIGS. 2 and 3, which allows the lifting yoke 30 to raise and support the blade 20 via the crane 32. The cradle support 58 includes a support bed 60 defined by a generally rigid support member extending between a first bed end 62 and a second bed end 64. The support bed 60 also includes an upper profiled surface 66 between the first and second bed ends 62, 64 that is specifically configured to receive and support a downward-facing surface 44b of the blade 20. As shown in FIG. 3, the upper profiled surface 66 may be formed in a saddle-like or cradle-like structure that projects from the support bed 60 and defines a contacting surface that is adapted to match an actual size and shape profile of the blade 20 to be supported. It will be appreciated that this saddle-like or cradle-like structure forming the upper profiled surface 66 may be configured in some optional embodiments to be replaceable such that the cradle support 58 can be reconfigured for use with different shapes and styles of blades 20. By generally matching the size and shape or profile of the blade 20, the support bed 60 provides a large and consistent contact surface of engagement with the blade 20, and this avoids application of localized high stress concentrations and/or localized significant variations in bending loads applied to the blade 20 during lifting and movement with the lifting yoke 30.

The support bed 60 when in use extends generally transverse to the longitudinal length of the blade 20 and the support beam 42, which also means that the support bed 60 is generally aligned with and located underneath the transverse beam member 52 at the second end 50 of support beam 42. As such, the first and second bed ends 62, 64 are separately connected to the first and second ends 54, 56 of the transverse beam member 52 via one or more lines now described in further detail. In this regard, the first bed end 62 is shown connected by two lines to the first end 54 of the transverse beam member 52 (at the second end 50 of support beam 42): a primary connection line 70 that extends into engagement with a release device 72 located on the first bed end 62 in this embodiment, and a secondary control line 74 that extends into engagement with a brake device 76 located on the first bed end 62. The release device 72 and the brake device 76 are actively controlled elements described in further detail below. By contrast, only a single connection line 78 extends into engagement and connects the second bed end 64 and the second end 56 of transverse beam member 52. Each of these lines 70, 74, 78 is configured to bear a full weight of the support bed 60, and the lines 70, 74, 78 are generally connected to eyelet-like connectors as shown in a simplified fashion in the drawing views, except for ends at the release device 72 and the brake device 76. As a result of the various connections by the lines 70, 74, 78, the support bed 60 is suspended underneath the support beam 42 such that the support bed 60 can carry the blade 20 as shown along the downward-facing surface 44b, and no part of the lines 70, 74, 78 or the support beam 42 needs to be in contact with the blade 20 during such movement and support.

The lifting yoke 30 of this embodiment is advantageously configured to be self-releasing from the blade support position when repair or installation actions are completed at the blade 20. In this regard, the release device 72 and the brake device 76 on the cradle support 58 are configured to operate a disengagement of the support bed 60 from the blade 20 so that the lifting yoke 30 can be moved directly away from the blade 20 without necessitating an “unthreading” of the support beam 42 and support elements by moving such along an entire length and over the tip end 24 of the blade 20 (as must be done with conventional T-yoke designs). The various operational states of this self-release are shown in FIGS. 3-5.

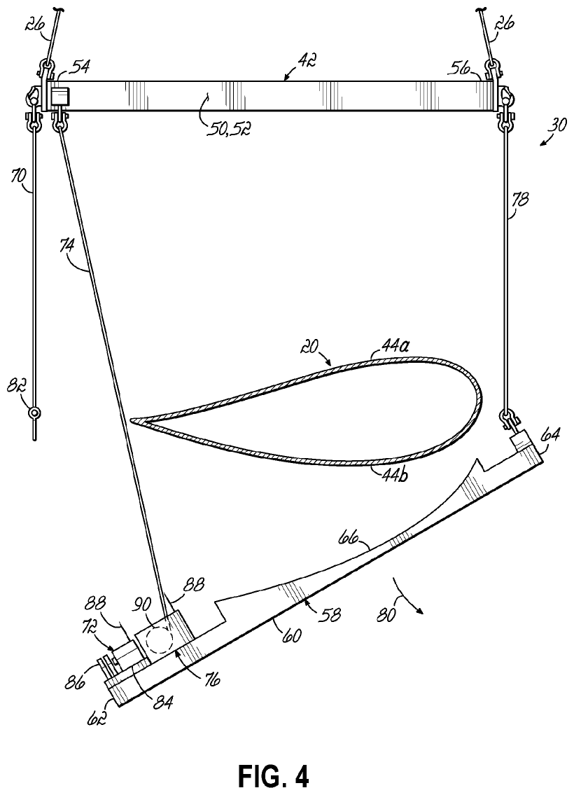

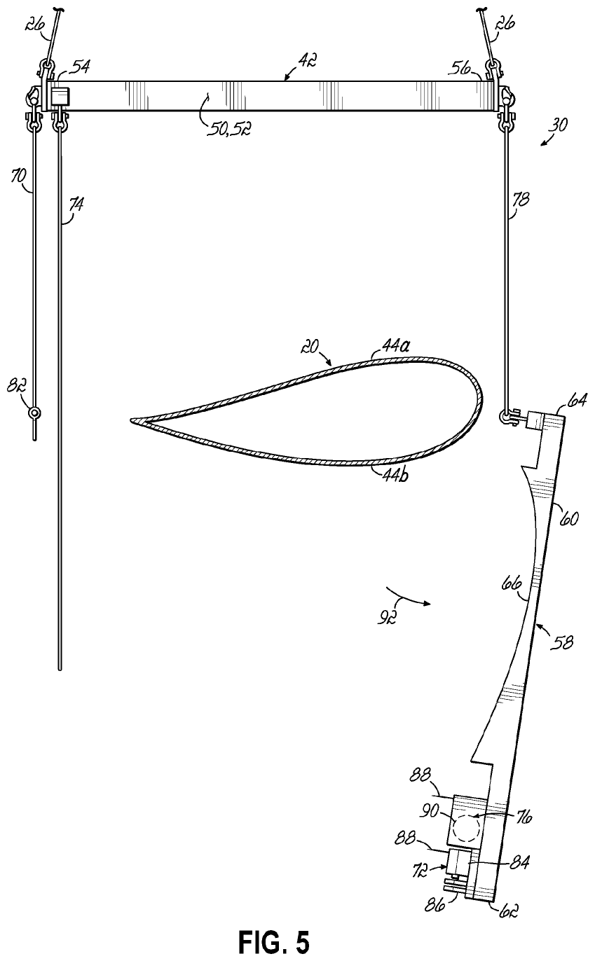

Starting with FIG. 3, the cradle support 58 is initially located in the blade support position described in detail above, which has the support bed 60 in contact with the blade 20 as the upper profiled surface 66, and the support bed 60 held in position relative to the support beam 42 by all of the lines 70, 74, 78. The cradle support 58 may then be released from this position as shown in FIGS. 4 and 5. Starting from the operational position shown in FIG. 3, the release device 72 is first activated to disconnect the primary connection line 70 from the first bed end 62 (or alternatively in non-illustrated embodiments, from the second end 50 of support beam 42). Such disconnection allows the first bed end 62 to begin to fall downwardly by gravity away from the blade 20, as shown by movement arrow 80 in FIG. 4. To this end, the single connection line 78 at the second bed end 64 remains connected at all times during this release process, so the disconnection of the primary connection line 70 results specifically in a pivotal movement of the support bed 60 generally about a pivot point defined at the connection of the second bed end 64 to the single connection line 78.

As described further below, the secondary control line 74 has additional length that can be metered out or released during this pivotal movement of the support bed 60 as shown by the longer length of the secondary control line 74 in FIG. 4, but the gravitational force still pulls the support bed 60 downwardly for the pivotal movement described.

The release device 72 of the cradle support 58 may be provided by any actively-controlled mechanism or device that operates to retain a connection (to the primary connection line 70) until it is desired to disconnect and release that connection. As one example, the release device 72 can include a release pin 82 mounted on one end of the primary connection line 70 and an electric motor 84 and pin receptacle 86 mounted on the first bed end 62. The electric motor 84 operates to selectively engage or disengage a locking member (or the like) at the pin receptacle 86 from the release pin 82, which allows for the disconnection of the primary connection line 70 to be actuated on demand by operation of the electric motor 84. The motor 84 is shown with an antenna 88 in this embodiment so that the release device 72 is configured to be controlled/actuated wirelessly by transmission of wireless control signals via antenna 88, such as from the control cab of the crane 32 or elsewhere on the ground surface. In other embodiments for performing this self-releasing function, further types of release devices 72 may include mechanically driven retention clip or hook devices (the clip or hook being openable to release the end of the primary connection line 70 on actuation), openable latch-and-shackle arrangements, a magnetic release mechanism (opened by application of current, for example), interlocked hinge portions joined by a moveable pin, a pulling mechanism for releasing a knot connection, and the like. Although shown on the support bed 60 at first bed end 62 in the illustrated embodiment, it will also be appreciated that the release device 72 can alternatively be mounted on the transverse beam member 52 so as to disconnect the primary connection line 70 at an opposite end thereof, with the only difference in such an alternative configuration being that the primary connection line 70 will hang downwardly from the first bed end 62 after disconnection rather than from the support beam 42 as shown in the drawing views. Such variations are within the scope of this invention as they continue to provide the same technical operations and benefits as described throughout this application.

Continuing with the self-release operation at FIG. 4, the control provided by the brake device 76 is provided as follows. During an initial/first portion of the pivotal movement of the support bed 60 between the positions shown in FIGS. 3 and 4, the brake device 76 limits a speed of the pivotal movement by slowing or controlling a release rate of the additional length of the secondary control line 74, as the secondary control line 74 continues to connect the second end 50 of support beam 42 with the first bed end 62 in this operational state. In one example, the brake device 76 includes a motor 90 and a resistor (not separately shown) connected to the motor 90, the motor and resistor operating to apply a braking torque or force on movement of the secondary control line 74 as it releases or moves past the motor 90. To this end, the brake device 76 may be configured to allow the secondary control line 74 (e.g., a rope) to move past the motor 90 when the primary connection line 70 is disconnected, but the braking torque or force applied effectively slows how quickly the first bed end 62 can fall downwardly in the pivotal movement away from the support beam 42 and blade 20. As a result, during the first portion of the pivotal movement between FIGS. 3 and 4, which may preferably include at least the first 45° of pivotal rotation about the second bed end 64, the brake device 76 limits a speed of the pivotal movement to avoid having gravity pull the support bed 60 into a rapid and uncontrolled swinging motion. Advantageously, this avoidance of uncontrolled swinging motions reduces any likelihood that the support bed 60 will swing back and impact the blade 20 after the self-release.

The brake device 76 in the illustrated embodiment also includes an antenna 88 that may be configured to receive wireless control signals for selectively operating the motor 90 and resistor as needed. Alternatively, the motor 90 and resistor in this embodiment of the brake device 76 may be automatically actuated to apply the braking torque or force as soon as movement of the secondary control line 74 begins. In other embodiments for performing this braking function, further types of brake devices 76 may be used. In one specific alternative, the brake device 76 is defined by a winch device that receives a portion of the secondary control line 74 (e.g., on or past a reel thereof), the winch device being operable to actively control movement of the secondary control line 74 relative to the first bed end 62. When using a winch device for the brake device 76, the winch device could be used to help hoist the support bed 60 back into a blade support position when the lifting yoke 30 is to be used again, such as on another blade 20. The operation of a standard winch device will be well understood in this art and therefore is not described in further detail herein. In further examples, the brake device 76 may include mechanical/frictional rope brake devices, frictionally-mounted or mechanically-controlled pulleys engaging with the secondary control line 72, actuatable clamps that apply a selectively adjustable amount of resistance to line movements, or the like. Although shown on the support bed 60 at first bed end 62 in the illustrated embodiment, it will also be appreciated that the brake device 76 can alternatively be mounted on the transverse beam member 52 so as to disconnect the secondary control line 74 at an opposite end thereof, with the only difference in such an alternative configuration being that the secondary control line 74 will hang downwardly from the first bed end 62 after disconnection rather than from the support beam 42 as shown in the drawing views. Such variations are within the scope of this invention as they continue to provide the same technical operations and benefits as described throughout this application.

After the brake device 76 slows the first portion of the pivotal movement, the secondary control line 74 is also released by disengagement of same from the brake device 76. For example, this disengagement can occur by the length of the rope defining the secondary control line 74 simply running out as it moves past the brake device 76, which may occur right after the support bed 60 swings to the operational position shown in FIG. 4. Alternatively, an active disengagement (by similar equipment as described for the release device 72) may be performed in other embodiments at this point. With both the primary connection line 70 and the secondary control line 74 disconnected at this point, the support bed 60 then freely continues to pivot as a result of gravity about the connection at the second bed end 64. This further pivotal movement is indicated by movement arrow 92 in FIG. 5. Although the support bed 60 will swing by its own weight about the second bed end 64 until it settles into the released position shown in FIG. 5, the control performed by the brake device 76 during the first portion of the pivotal movement generally prevents a significant back-and-forth uncontrolled swinging of the support bed 60 that could impact the support bed 60 with the blade 20 again and potentially cause damage. Thus, the lifting yoke 30 and specifically the cradle support 58 is selectively self-released when repair or installation actions are completed, allowing for a simple and quick removal of the lifting yoke 30 from the vicinity of the blade 20 thereafter.

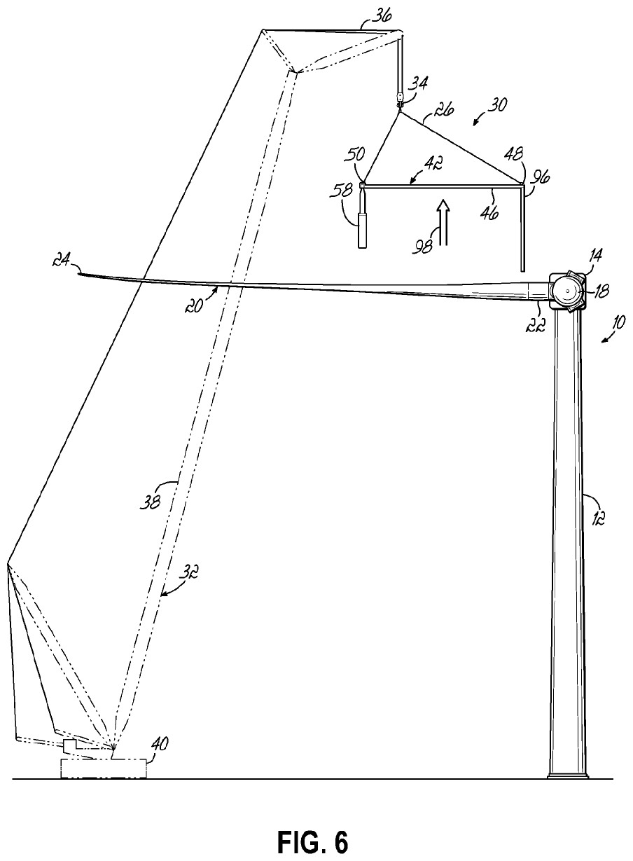

In this regard, reference is now made to FIGS. 5 and 6. After the cradle support 58 has been released to the position shown in FIG. 5, the support element 96 at the root end 22 of the blade can also be disconnected at least in part from the first end 48 of support beam 42 to release the support element 96 from supporting engagement with the blade 20 at that location. The support element 96 may take one of several different forms as described in the next paragraph, although the support element 96 is illustrated as a support sling in the example shown in FIGS. 2 and 6. Regardless, with the cradle support 58 and the support element 96 disengaged or released from the blade 20, the lifting yoke 30 is free to be moved directly away from the region of the blade 20 by the crane 32, such as with movement shown by arrow 98 in FIG. 6. It will be understood from these illustrations that the movement of the lifting yoke 30 away from the blade 20 can be done in a direction transverse to the longitudinal length of the blade 20, as the cradle support 58 and the support element 96 no longer wrap around the periphery of the blade 20 in such a manner that would require “unthreading” by moving these all the way along the length of the blade 20 and over the tip end 24.

Consequently, the crane 32 does not need to be configured to move the lifting yoke 30 along an entire (long) length of the blade 20, which is a significant limitation imposed when using a conventional T-yoke for lifting and moving a blade 20. Likewise, any potential damage that could occur by impacts of the lifting yoke 30 against the blade 20 during an “unthreading” movement is automatically avoided when using the lifting yoke 30 of the present invention, and the crane 32 and lifting yoke 30 can be more quickly made available and ready for another support action (e.g., such as for another blade 20 to be repaired or installed).

As described above, the support element 96 located at the first end 48 of the support beam 42 is configured to support the root end 22 of the blade 20, and as such, the support element 96 may be provided in different forms depending on the preferences of the end user. In one example, the support element 96 is a second cradle support having all of the elements previously described and shown in detail at cradle support 58. In such an alternative, the support beam 42 may include another transverse beam member on the first end 48 to define more of an I-shape than a T-shape configuration, but in all other respects, the functionality of the cradle support is simply repeated. Such a configuration may be desired when a user wants to provide a bed-like support and lower stresses at all regions of the wind turbine blade 20. In another alternative as shown in the Figures, the support element 96 is a simple support sling, formed from a flexible piece/loop of material, that is configured to wrap around the blade 20 at the root end 22. This may be desirable to further simplify the structure (as one fewer support bed 60 and brake device 76 would be needed in this alternative, but a release device 72 would still be required to allow for the selective disengagement described above), and this is typically made possible because the root end 22 is not as prone to damage occurring from high localized stresses that may be applied when supporting and moving with a sling. These and further alternatives for the support element 96 may be used without departing from the scope of the present invention, as long as the functionality of selective release to allow for direct movement of the lifting yoke 30 away from the blade 20 is maintained.

Returning with reference to FIGS. 2-6, the method of moving and supporting a wind turbine blade 20 with the lifting yoke 30 is summarized as follows. The support beam 42 of the lifting yoke 30 is positioned by the crane 32 generally above the center of gravity of the blade 20, and then the support element 96 is connected to the first end 48 of support beam 42 and to the root end 22 of blade, while the cradle support 58 is connected to the second end 50 of support beam 42 and to the blade 20 at a location between the center of gravity and the tip end 24. It will be understood that the support element 96 and the cradle support 58 may be fully pre-assembled to the support beam 42 and then “threaded” onto the blade 20 by moving the lifting yoke 30 along the length of the blade 20 starting over the tip end 24, or may alternatively be secured in final position after the support beam 42 is moved above the blade 20. In any event, the lifting yoke 30 is then lifted at the support beam 42 by the crane 32, which causes the blade 20 to be lifted and moved via the cradle support 58 and the support element 96, the blade 20 being moved to an installation position while the lifting yoke 30 is in this blade support position as shown in FIGS. 2 and 3. Once installation and/or repair are completed and the blade 20 is attached to the hub 18 again, the cradle support 58 is released from connection to the blade 20, which may specifically be done by first activating the release device 72 and then controlling, with the brake device 76, a speed of pivotal movement of the support bed 60 during at least the first portion of the pivotal movement. The support element 96 is also disengaged from the blade 20 at the root end 22. The lifting yoke 30 is then moved transversely and directly away from the proximity of the blade 20 without requiring the lifting yoke 30 to be moved along an entire longitudinal length and over the tip end 24 of the blade 20.

Accordingly, the lifting yoke 30 of the embodiments described herein provides several improvements over the conventional lifting yoke and installation apparatus designs. As the only actively controlled elements on the lifting yoke 30 are the release device 72 and the brake device 76 (or multiples of these depending on which specific support elements 96 are used), complex control lines from the crane 32 and/or hydraulics on the lifting yoke 30 can be avoided altogether. Such a configuration simplifies the manufacture and operations of the lifting yoke 30 to provide a relatively simple-in-complexity end solution in the style of conventional T-yokes. The lifting yoke 30 is thus also significantly lighter in weight and more easily manipulated by the crane 32 than conventional installation apparatus designs that may use C-clamp shaped carrying elements. Furthermore, the enhanced support of the blade 20 with bed-like supports and the versatility of the lifting yoke 30 to work with many different styles of blades 20 is made possible without requiring “unthreading” movements of the supports over the entire length of the blade 20 after use. The lifting yoke 30 therefore significantly improves wind turbine blade installation and repair actions.

While the present invention has been illustrated by a description of various preferred embodiments and while these embodiments have been described in some detail, it is not the intention of the Applicant to restrict or in any way limit the scope of the appended claims to such detail. Additional advantages and modifications will readily appear to those skilled in the art. Thus, the various features of the invention may be used alone or in any combination depending on the needs and preferences of the user.

1. A lifting yoke for supporting and moving a wind turbine blade during installation or service at a wind turbine, the blade including a root end , a tip end opposite the root end, and a center of gravity located therebetween, the lifting yoke comprising:
an elongate support beam configured to be lifted and moved by a crane, the support beam including a first end and a second end along a length of the support beam;
a support element connected to the first end of the support beam and configured to wrap around the blade proximate the root end; and
a cradle support connected to the second end of the support beam and configured to lift and support the blade at a location between the center of gravity and the tip end, characterized in that the cradle support comprises:
a support bed including an upper profiled surface that is configured to receive and support a downward-facing surface of the blade, the support bed extending along a length generally transverse to the length of the support beam and between a first bed end and a second bed end, each of the first and second bed ends being connected by a separate line to the second end of the support beam;
a release device connected to the line at the first bed end and operative to disconnect the first bed end from the second end of the support beam, thereby allowing the support bed to pivot about the second bed end away from the blade; and
a brake device operatively connected to the first bed end and configured for controlling the pivotal movement of the support bed for a first portion of movement following disconnection of the first bed end from the second end of the support beam by the release device, the brake device configured for disengaging after the first portion of movement to allow continued pivotal movement of the support bed about the second bed end while the second bed end remains connected by the line to the second end of the support beam.

2. The lifting yoke of claim 1, characterized in that the first portion of movement includes at least 45° of pivotal rotation of the support bed about the second bed end, such that the brake device only disengages after at least 45° of pivotal rotation.

3. The lifting yoke of claim 1, characterized in that the line connecting the first bed end to the second end of the support beam is a primary connection line that is engaged with the release device, and the lifting yoke is further characterized by:
a secondary control line connecting the first bed end with the second end of the support beam and running generally parallel to the primary connection line, and
the brake device is engaged with the secondary control line such that the secondary control line continues to initially maintain a connection between the first bed end and the second end of the support beam after the release device disconnects the primary connection line from one of the first bed end and the second end of the support beam.

4. The lifting yoke of claim 3, wherein the brake device is characterized by:
a motor and a resistor connected to the motor configured for applying a braking torque or force to movement of the secondary control line past the motor, the braking torque or force slowing release of the secondary control line past the motor such that the pivotal movement of the support bed downwardly at the first bed end is limited in speed through the first portion of movement.

5. The lifting yoke of claim 3, wherein the brake device is characterized by:
a winch device that receives the secondary control line and configured for actively controlling movements of the secondary control line relative to the first bed end, the winch device operating to limit a speed of release of the secondary control line through the winch device such that the pivotal movement of the support bed downwardly at the first bed end is limited in speed through the first portion of movement.

6. The lifting yoke of claim 3, wherein the release device is characterized by:
a release pin connected to the primary connection line, and a motor and a pin receptacle connected to the support bed, the motor operating selectively to disengage the release pin from the pin receptacle to thereby disconnect the primary connection line from the support bed.

7. The lifting yoke of claim 1, characterized in that each of the release device and the brake device is mounted on the support bed and adjacent the first bed end.

8. The lifting yoke of claim 7, characterized in that each of the release device and the brake device includes an antenna for wirelessly receiving control signals to operate the respective disconnecting and slowing pivotal movement functions.

9. The lifting yoke of claim 1, characterized in that the upper profiled surface of the support bed is adapted to match an actual size and shape profile of the blade to be supported at the cradle support.

10. The lifting yoke of claim 1, characterized in that the elongate support beam is a T-shaped beam including a transverse beam member extending along the second end, and opposite ends of the transverse beam member being connected by the separate lines to the first and second bed ends of the cradle support.

11. The lifting yoke of claim 1, characterized in that the support element connected to the first end of the support beam includes one of the following:
a support sling defined by a generally flexible length of material configured to wrap closely around the blade proximate the root end; or
a second cradle support including a support bed with an upper profiled surface, a release device, and a brake device each functioning identically to corresponding elements of the cradle support connected to the second end of the support beam.

12. The lifting yoke of claim 11, characterized in that after installation or service of the wind turbine blade, and when each of the cradle support connected to the second end of the support beam and the support sling or second cradle support connected to the first end of the support beam is released from engagement with the blade, the lifting yoke can be moved directly away from the blade without moving the lifting yoke along an entire length of the blade and/or over the tip end thereof.

13. The lifting yoke of claim 1, characterized in that the release device and the brake device define the only actively controlled elements on the lifting yoke.

14. A method of moving and supporting a wind turbine blade during installation or service at a wind turbine, the blade including a root end, a tip end opposite the root end, and a center of gravity therebetween, the method characterized by:
positioning an elongate support beam of a lifting yoke to be spaced apart from an upward-facing surface of the blade and above the center of gravity of the blade, with the elongate support beam extending from a first end located proximate the root end of the blade to a second end located above the blade between the center of gravity and the tip end of the blade;
connecting a support element to the first end of the support beam and wrapping the support element around the blade to support the blade proximate the root end;
connecting a cradle support to the second end of the support beam, the cradle support including a support bed with an upper profiled surface and extending between first and second bed ends, a release device, and a brake device, and engaging the cradle support with the blade at a location between the center of gravity and the tip end by contacting the upper profiled surface with the blade while the first and second bed ends are connected to the second end of the support beam with separate lines;
lifting the lifting yoke at the elongate support beam to thereby lift and support the blade at the support element and at the cradle support; and
releasing engagement of the cradle support from the blade when installation or service of the blade is completed, the releasing engagement being characterized by:
activating the release device of the cradle support to disconnect the line at the first bed end from the support bed; and
controlling, by the brake device, a speed of pivotal movement of the support bed downwardly after activating the release device to slow the pivotal movement about the second bed end for at least a first portion of the pivotal movement.

15. The method of claim 14, characterized in that the first portion of the pivotal movement includes at least 45° of pivotal rotation of the support bed about the second bed end, and the step of releasing engagement of the cradle support from the blade is further characterized by:
disengaging the brake device only after the support bed has moved through at least 45° of pivotal rotation, thereby allowing the support bed to freely continue the pivotal movement downward and away from the blade.

16. The method of claim 14, characterized in that the line connecting the first bed end to the second end of the support beam is a primary connection line, the lifting yoke further includes a secondary control line connecting the first bed end with the second end of the support beam, and the step of connecting the cradle support to the second end of the support beam is further characterized by:
engaging the release device with the primary connection line such that the release device is configured to selectively disconnect the primary connection line from the first bed end; and
engaging the brake device with the secondary control line such that the brake device is configured to control movements of the first bed end along the secondary control line.

17. The method of claim 16, characterized in that the brake device includes a motor and a resistor connected to the motor, and the step of controlling the speed of pivotal movement is further characterized by:
applying a braking torque or force with the motor and the resistor to limit movement of the secondary control line past the motor .

18. The method of claim 16, characterized in that the brake device includes a winch device, and the step of controlling the speed of pivotal movement is further characterized by:
actively controlling, by the winch device, a speed of movement of the secondary control line through the winch device.

19. The method of claim 14, characterized in that each of the release device and the brake device includes an antenna for wireless communications of control signals, and the step of releasing engagement of the cradle support is further characterized by:
sending wireless control signals to the antennas of the release device and the brake device to remotely and sequentially cause the step of activating the release device and the step of controlling the speed of pivotal movement with the brake device.

20. The method of claim 14, wherein after the step of releasing engagement of the cradle support from the blade, the method is further characterized by:
disengaging the support element from the blade proximate the root end of the blade; and
moving the lifting yoke transversely and directly away from the blade without moving the lifting yoke along an entire length of the blade and/or over a tip end thereof.
